(19) United States
(12) Patent Application Publication
(10) Pub. No.: US 2006/0290789 A1
(43) Pub. Date: Dec. 28, 2006

(54) File naming with optical character recognition

(75) Inventor: Pekka Ketola, Tampere (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/158,697

(22) Filed: Jun. 22, 2005

(51) Int. Cl. H04N 5/76

(52) U.S. Cl. 348/231.99; 348/231.2

(57) ABSTRACT

Optical character recognition (OCR) is used in conjunction with digital images to recognize characters or text in the image for use in naming the file. An OCR module analyzes the digital image to identify characters. The characters so identified may be used in naming the file for storage in a memory unit. The use of characters to name the file provides a more informative name than default name systems. Thus, a user is able to better locate a specific digital image file based upon its file name.

### FIELD OF THE INVENTION

The present invention relates generally to electronic devices having digital camera functionality. More particularly, the present invention relates to digital camera devices which utilize optical character recognition to name image files.

### BACKGROUND OF THE INVENTION

Digital cameras are quickly becoming the principal photography device for most households. Indeed, many electronic devices are being integrated with digital camera functionality. For example, mobile telephones which include a digital camera are becoming increasingly common. The digital format allows users to easily and economically take and share large numbers of photographs. As a result, there is a need for an organizational system in storing the digital images.

One common problem that arises with current storage systems concerns the naming of each electronic file. In general, digital cameras save image files using a file name that is determined manually or via a default naming system. Manual entry normally allows for a more meaningful name to be assigned to a file. However, this is a rather arduous task with most digital cameras due to the relatively small size of the user interface. In addition to manual naming, most digital cameras include a default naming mechanism. Various systems are known in the art for providing a default name for files. Perhaps the most common default naming system involves a consecutive naming system where each file is named with a number in a consecutive sequence.

However, default naming, even where consecutive, often provides little or no useful information regarding the file. This makes it hard to recognize a specific image based on the file name. In fact, this problem is exacerbated as the memory size of devices grows, since this will often result in many more images stored in the memory of the device. In addition, where a user transfers files from a digital camera to another electronic device, such as a computer, different files often have the same name. This is particularly true where the default naming system involves a small series of numbers, or where the default naming system resets often, thus generating different images with the same file name. Also, image galleries on personal computers or web servers can hold a plethora of pictures, making it difficult to locate a specific picture where the default name is not known. Therefore, it would be beneficial to have an image named according to some memorable feature which serves to identify the content of the image to a user.

### SUMMARY OF THE INVENTION

The present invention provides for the naming of digital camera image files using optical character recognition (OCR). A device incorporating the present invention can identify characters in an image and use those characters for creating a file name for storing the image in a memory unit. OCR refers to the branch of computer science that involves reading text from an image and translating the images into a form that the computer can manipulate (for example, into ASCII codes).

When an image is captured, a digital camera of the present invention automatically performs OCR for the image and determines if there is any text in the image. If text is found, then the image is either named according to the text, or the text can be proposed to a user, with the user allowed to select and/or edit the file name. This ability to select the name is especially useful in situations where there is more than one text string in an image. Thus, the name of the image is more easily recognizable than when default names are used. A user is able to better identify, organize, and find images with the help of more appropriate file names with the present invention.

In one embodiment of the present invention, more than one text item may be present in an image. The image is named according to a selected criteria or a group of criteria such as, but not limited to, the text size, text color, text length, the position of the text in the image, and combinations thereof. In one embodiment of the present invention, a user may select from a plurality of settings which determine what naming scheme is used.

These and other objects, advantages, and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a sectional side view of a generic digital camera according to the principles of the present invention;

FIG. 2 is a perspective view of a mobile telephone that can be used in the implementation of the present invention;

FIG. 3 is a schematic representation of the telephone circuitry of the mobile telephone of FIG. 2; and

FIG. 4 is a flow diagram showing a generic process for the implementation of the present invention.

### DETAILED DESCRIPTION OF THE PREFERRED EMBODIMENTS

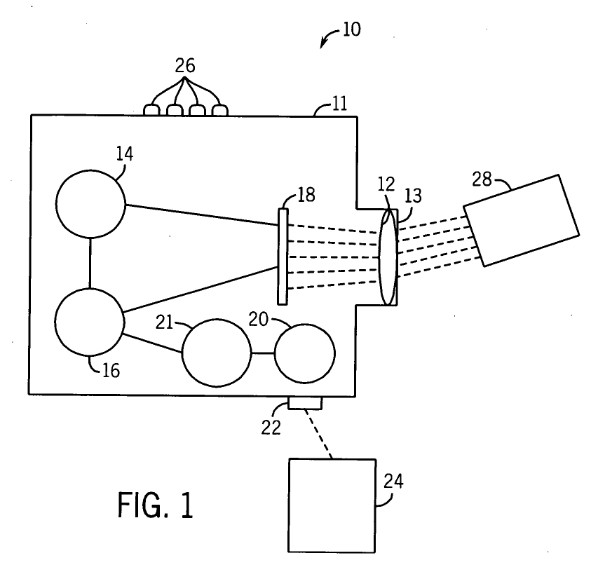

A generic digital camera constructed according to one embodiment of the present invention is shown at 10 in FIG. 1. The digital camera 10 can be a stand-alone device or can be incorporated into another electronic device, such as a portable telephone. The digital camera 10 includes a housing 11 which contains a shutter 13 covering at least one lens 12, a primary memory unit 14, a camera processor 16, and at least one image sensor 18. The primary memory unit 14 can be used to store digital images and computer software for performing various functions in the digital camera 10, as well as to implement the present invention. In one embodiment, a removable, secondary memory unit 20, in the form of a memory card, can also be included in the digital camera 10 to provide extra memory space. In one embodiment, the image sensor 18 can be a charge coupled device (CCD), a complementary metal oxide semiconductor (CMOS), or another system as known in the art. An OCR module 21 is provided, which may include software and/or hardware. The OCR module 21 may be integral to the digital camera 10 (as shown in FIG. 1) or may be located remote from the digital camera 10.

When a digital file capturing an image 28 is created, the at least one lens 12 focuses the image 28 onto the at least one image sensor 18 which electronically records light reflected from the image 28. The camera processor 16 then breaks this electronic information down into digital data (via an analog-to-digital conversion) for a digital image which can be stored on a memory unit, such as the primary memory unit 14 and/or the secondary memory unit 20, as a file. The digital camera 10 also includes a data communication port 22 to enable the transmission of digital images from the digital camera 10 to a remote terminal, such as a personal computer 24. The data communication can be in either wired or wireless form and can be configured for USB, Bluetooth, infrared, or other connections. The digital camera 10 also includes one or more input buttons 26 for entering information and/or taking a picture, although input buttons 26 could also be remote from the digital camera 10.

The digital camera of the present may be one component of another device such as a video camera, a mobile telephone, a personal digital assistant, a watch, or an audio player. When the digital camera is a component of another device, various parts may be common to the devices. For example, in one embodiment of the present invention, a mobile telephone includes a digital camera component and a telephone component, both of which may share a housing, memory, OCR, processor, etc.

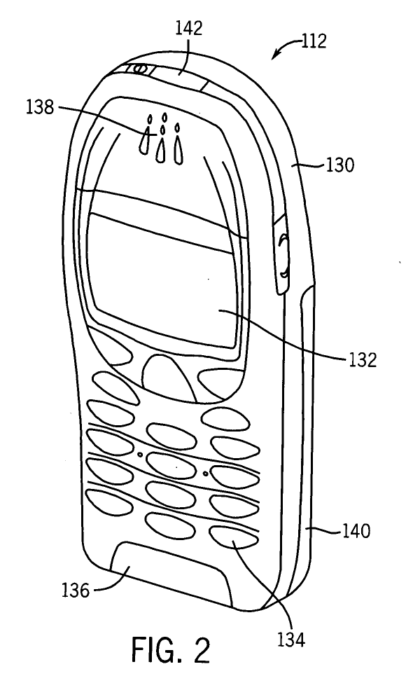

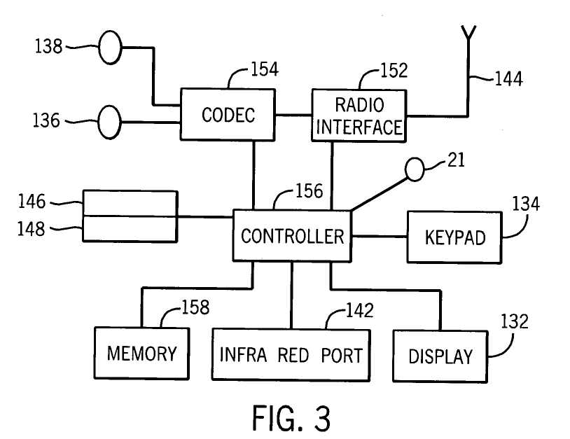

FIGS. 2 and 3 show one representative mobile telephone 112 within which the present invention may be implemented. It should be understood, however, that the present invention is not intended to be limited to one particular type of mobile telephone 112 or other electronic device. FIG. 2 depicts a mobile telephone having digital camera functionality in accordance with the principles of the present invention. The mobile telephone 112 of FIG. 2 includes a housing 130, a display 132 in the form of a liquid crystal display (LCD), a keypad 134, a microphone 136, an ear-piece 138, a battery 140, an infrared port 142, an antenna 144, a smart card 146, in the form of a universal integrated circuit card (UICC) according to one embodiment of the invention, a card reader 148, radio interface circuitry 152, codec circuitry 154, a controller 156 and a memory 158. It should be noted that the controller 156 can be the same unit or a different unit than the camera processor 16. Individual circuits and elements are all of a type well known in the art, for example in the Nokia range of mobile telephones. Other types of electronic devices within which the present invention may be incorporated can include, but are not limited to, personal digital assistants (PDAs), integrated messaging devices (IMDs), desktop computers, and notebook computers. FIG. 3 illustrates a schematic of the components of the mobile phone 112 of FIG. 2.

All OCR systems include an optical scanner for reading text and software for analyzing images. As used in this application, OCR refers to all types of optical scanning systems such as, but not limited to, OCR, intelligent character recognition (ICR), and optical mark reading (OMR). In one embodiment of the present invention, the optical scanner comprises the digital camera 10. In addition, most OCR systems use a combination of hardware (such as specialized circuit boards) and software to recognize characters, although some systems function entirely through software. In accordance with the principles of the present invention, OCR can be used to identify characters and/or words in an image. There are two common methods used for OCR: matrix matching and feature extraction.

In one embodiment of the invention, matrix matching is utilized. Matrix matching compares what the OCR module 21 sees as a character with a library of character matrices of dots. When a character matches one of these prescribed matrices of dots within a given level of similarity, the computer labels that image as the corresponding ASCII character. Matrix matching works best when the OCR encounters a limited repertoire of type styles, with little or no variation within each style.

In another embodiment, feature extraction is utilized. Feature extraction is OCR without a reliance on matching to predetermined templates. Feature matching is typically referred to as ICR or Topological Feature Analysis. This method relies on the software to perform an “intelligent” analysis of the image. For example, in one embodiment, an OCR module using feature extraction looks for general features, such as open areas, defined shapes, horizontal, diagonal, and vertical lines, and line intersections. In general, matrix matching works best when the image contains only basic text fonts, sizes, and variations of text. In contrast, feature extraction generally provides superior results where the characters are less predictable.

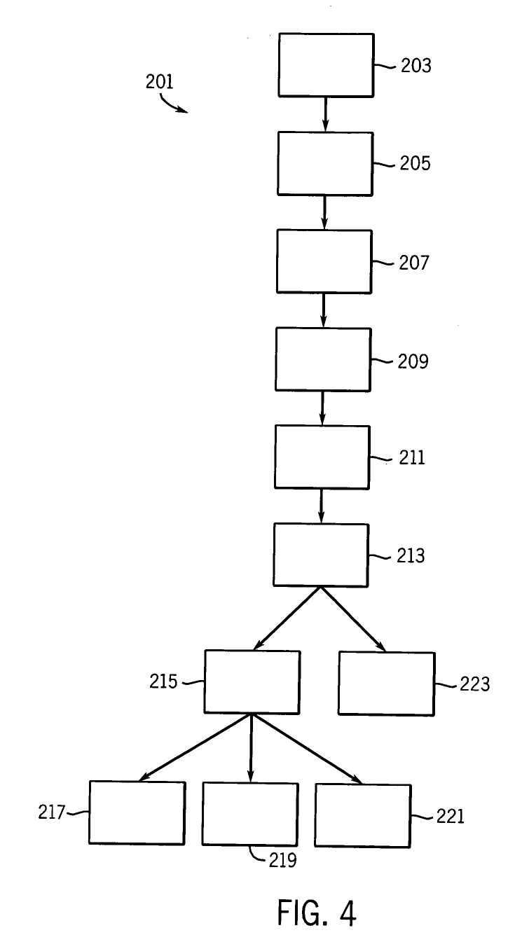

FIG. 4 is a flow chart showing the operation of one embodiment of the implementation of the present invention. A method 201 of determining a file name for an image using OCR includes momentarily opening the shutter of the camera at step 203. Once the shutter 13 has momentarily opened at step 203, the light reflected from the image is focused by the lens 12 at step 205. The focused light is then converted to electrons as an accumulated charge at step 207. This is accomplished using one of the known image sensors 18 such as, but not limited to, CMOS or CCD. At step 209, the accumulated charge is converted into a digital value by the camera processor 16 to form a digital image file. An OCR module 21, which may comprise hardware, software, or a combination of both, processes the digital information of the image at step 211 in order to identify any characters in the digital image file. In one embodiment, the characters are assembled them into words at step 213. The digital image file may be named according to the output of the OCR processing step 211 and saved in memory.

In accordance with the principles of the present invention, file naming with OCR can work as part of capturing a new image, or as part of browsing existing images. In one embodiment, the OCR module 21 operates on an image immediately after it is captured and processed into a digital format by the camera processor 16. In an exemplary embodiment, the user is prompted at step 215 to save the image with a file name suggested from the text recognized by the OCR module 21. In one exemplary embodiment, following suggestion of a file name at step 215, the user may accept the proposed new name (step 217), reject the new name (step 219), or manually change the name (step 221). In another embodiment, the image is automatically saved at step 223 using the assembled words from step 213.

In another embodiment of the invention, the OCR module 21 operates to analyze a digital image file when the digital image files is selected to be viewed. A suggested new file name for the image is provided based upon the OCR. The image may then be saved using this new, more-informative file name. In one embodiment, the prior file having the default name is deleted when the image is renamed based upon OCR.

In an exemplary embodiment, an image file is saved using a combination of information from the OCR module 21 and default data, such as a consecutive numbering system or time/date/year information.

In one embodiment of the present invention, a user may select from a plurality of settings which determine what naming scheme is used. The image is named according to a selected criteria or group of criteria such as, but not limited to, the text size, text color, text length, the position of the text in the image, and combinations thereof.

More than one text item may be present in an image. In one embodiment, the present invention includes one or more criteria for determining which of a plurality of text items in an image to use for naming the digital file. In one embodiment, a user may select one or more criteria for selecting one or more of the plurality of text to use in naming the digital image.

The following non-limiting examples illustrate operation of the invention. In one hypothetical situation, a user takes a holiday picture in the front of a hotel's main door using his or her camera-phone. While saving the picture, the phone's OCR module identifies the word “Hilton,” and proposes “Hilton June 23” as the default name for the picture. The user accepts the proposed file name and the image file is stored as “Hilton June 23.”

In another hypothetical scenario, a user browses images saved under a default naming system in a digital camera's memory. By background process, the phone OCR module is analyzing the pictures being browsed, and proposes a new name when the user opens a specific image.

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

Software and web implementations of the present invention could be accomplished with standard programming techniques, with rule based logic, and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments, and with various modifications, as are suited to the particular use contemplated.

What is claimed is:

1. A method for naming a digital file of an image, comprising:
analyzing the digital file for patterns;
recognizing any patterns in the digital image that correspond to characters; and
if any patterns are recognized as corresponding to characters, making the corresponding characters available for use in naming the digital image file for storage in a memory unit.

2. The method of claim 1, further comprising, before analyzing the image, capturing the image.

3. The method of claim 2, wherein capturing the image involves using at least one lens to focus the image onto at least one image sensor.

4. The method of claim 1, wherein the digital file is analyzed when the digital file is browsed by a user on an electronic device.

5. The method of claim 1, further comprising, after pattern recognition, indicating that characters are available for use in naming the digital file.

6. The method of claim 2, wherein the characters are assembled into words.

7. The method of claim 2, wherein the image is captured by a digital camera which comprises part of a camera-phone.

8. The method of claim 2 further comprising allowing rejection, acceptance, or alteration of the characters for use in naming the digital file for storage in the memory unit.

9. A computer program product, comprising:
computer code for analyzing a digital image for patterns;
computer code for recognizing patterns in the digital image that correspond to characters; and
computer code for, if any patterns are recognized as corresponding to characters, making the corresponding characters available for use in naming the digital image file for storage in a memory unit

10. The computer program product of claim 9, wherein the digital image is stored in a memory unit as a file.

11. The computer program product of claim 10, further comprising computer code for browsing the digital image.

12. The computer program product of claim 11, further comprising computer code for analyzing the digital image file when the digital image file is browsed by a user on an electronic device.

13. The computer program product of claim 11, further comprising computer code for indicating, after pattern recognition, that the characters are available for use in naming the digital image file.

14. The computer program product of claim 10, computer code for suggesting a file name for the digital file based upon the character

15. An electronic device, comprising:
a processor for processing information;
a memory unit operatively connected to the processor; and
a digital camera for creating a file of a captured image stored in the memory unit, the digital camera operatively connected to the processor,
wherein the memory unit includes:
computer code for analyzing the file for patterns;
computer code for recognizing patterns in the file that correspond to characters; and
computer code for, if any patterns are recognized as corresponding to characters, making the corresponding characters available for use in naming the file for storage in a memory unit

16. The electronic device of claim 15, wherein the electronic device includes a digital camera comprising part of a camera-phone.

17. The electronic device of claim 16, wherein the digital camera comprises a charge coupled device.

18. The electronic device of claim 16, wherein the memory unit further comprises computer code for allowing rejection, acceptance, or alteration of the characters for use in naming the file for storage in the memory unit.

19. The electronic device of claim 15, wherein the memory unit further comprises computer code for indicating that characters are available for use in naming the file.

20. The electronic device of claim 15, wherein the memory unit further comprises computer code for analyzing the digital image file when the file is browsed by a user on the electronic device.
